(19) United States
(12) Patent Application Publication
(10) Pub. No.: US 2021/0243332 A1
(43) Pub. Date: Aug. 5, 2021

(54) SYSTEM AND METHOD FOR PROCESSING COST ACCOUNTING FOR MULTIPLE DEVICE FUNCTIONS

(71) Applicant: Toshiba TEC Kabushiki Kaisha, Shinagawa-ku (JP)

(72) Inventors: Jia ZHANG, Irvine, CA (US); Christopher NGUYEN, Huntington Beach, CA (US)

(21) Appl. No.: 16/781,529

(22) Filed: Feb. 4, 2020

(51) Int. Cl. H04N 1/34; G06F 3/12

(52) U.S. Cl. CPC H04N 1/344; H04N 1/346; H04N 2201/0094; G06F 3/1239; G06F 3/1205

(57) ABSTRACT

A system and method for multiple account document processing cost accounting includes a multifunction peripheral including an intelligent controller having a processor and memory. A document processing engine operates in conjunction with instructions issued from the intelligent controller. The intelligent controller receives into memory document processing job data associated with a user. A user interface receives user input identifying the user. The user selects one or more charge based document processing operations to be performed. An account balance associated with the user is checked against one or more requested operations. User device operation permissions are assigned for each operation for which the user has sufficient credit in their account. Each document processing operation for which a permission has been given is completed, and the information is used to recalculate the user's account balance.

### TECHNICAL FIELD

This application relates generally to fee-based document processing operations wherein payments are made by debiting of individual user accounts in accordance with document processing functions they have used. The application relates more particularly to selective, individual enablement of document processing device functions for individual users based on a current value or quota level of their pre-paid accounts.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Given the expense in obtaining and maintain MFPs, devices are frequently shared or monitored by users or technicians via a data network. MFPs, while moveable, are generally maintained in a fixed location. Until more recent times, users, which may include individuals or groups such as employees, administrators or technicians administrators of networked MFPs, were also generally in relatively fixed location. A user would typically communicate documents or other information from his or her office or workstation to a selected MFP. An administrator or technician would also monitor MFPs from a workstation.

Users may send document processing jobs, such as a print request, to one or more networked devices. In a typical shared device setting, one or more workstations are connected via a network. When a user wants to print a document, an electronic copy of that document is sent to a document processing device via the network. The user may select a particular device when several are available. The user then walks to the selected device and picks up their job or waits for the printed document to be output. If multiple users send their requests to the same device, the jobs are typically queued and outputted sequentially. Given the expenses in printing documents, there may be an associated charge.

### BRIEF DESCRIPTION OF THE DRAWINGS

Various embodiments will become better understood with regard to the following description, appended claims and accompanying drawings wherein:

FIG. 1 is an example embodiment of a document processing accounting system;

FIG. 2 is an example embodiment of a networked digital device;

FIG. 3 is an example embodiment of a digital device;

FIG. 4 is an example embodiment of a multifunction peripheral use charge system;

FIG. 5 is an example embodiment of connector software modules;

FIG. 6 is a flowchart of an example embodiment of a system for device use cost accounting for different multifunction peripheral functions;

FIG. 7 is a first example embodiment of a user interface screen;

FIG. 8 is a second example embodiment of a user interface screen;

FIG. 9 is a third example embodiment of a user interface screen;

FIG. 10 is a fourth example embodiment of a user interface screen;

FIG. 11 is a fifth example embodiment of a user interface screen; and

FIG. 12 is a sixth example embodiment of a user interface screen.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Document printing operations may require a fee. All operations are associated with costs. All document operations require user access to, and operational time of, a device that can be expensive and further possesses a finite lifetime with regular device maintenance costs. All device operations consume electric power. While some operations, like faxing, e-mailing or scanning, do have costs associated with them, they are relatively small as compared to printing. Printing operations require mechanical interactions that place wear and tear on paper drive mechanisms and imaging mechanisms. Printing operations may consume substantially more power, particularly when heat fusing of toner is utilized. Printing operations also require consumption media, such as paper, and deposition components, such as ink or toner. Color printing can be even more expensive as it requires formation of colors by consumption of multiple colors of toner or ink.

Printing or copying may be subject to a fee, such as a per-page fee. Color printing or copying may be subject to a higher charge. In some situations, a user may pay their document processing fee directly on an MFP. Brick and mortar printing businesses such as FedEx Office, The UPS Store or Staples may have MFPs that a user can use to make fee-based copies or printouts. Payment can be made directly on a machine or via a networked pay terminal.

Fee-based document processing operations on devices such as MFPs may be implemented in situations other than brick-and-mortar shops such as noted above. Businesses may be charged per page of printing by a MFP distributor who also maintains and services the devices. Schools may have a mechanism to charge students for document processing. Payment can be made directly, as noted above. Alternatively, a student may have a page allotment or quota, such as a fixed number of pages or a fixed dollar amount for use per month, per quarter or per semester. In another example, a student may make an advance deposit and secure a credit for future document processing needs. A deposit may also be used to provide additional printouts, for example, if they have used up their allotment.

In another example employees may be giving document allotments, such as a preset dollar value per month. In a corporate environment, a user may need to identify an account against which their document processing fees are to be assessed. A shared account may be used by a group of employees with a shared value to use.

In an example user/device interaction commensurate with printing, a user would walk up to an MFP and login with their user credentials, such as username and password or any other suitable authentication process. The user would then enter information to identify their charge account. Once identified, the user could complete their document processing operations provided sufficient funds or use quotas remain available to them. It could be problematic if a user enters an account that is, for example, at or near depletion. A job may be refused or only partially completed with their available account value. A user may have alternative accounts at their disposal. By way of further example, a teacher may have a charge account for student handouts, another charge account for school functions, another account for administrative duties and yet another account for personal projects. A particular job may be chargeable to two or more accounts, either in the alternative or in combination. A user may have multiple accounts that might be used, but be unaware as to which one is optimal for balancing their account values. In such an instance, a user may just pick one account and improperly charge all costs to it. A user may also just keep trying available accounts until one has sufficient funds to do the needed job. A user may have also queued multiple print jobs, for example, with each print job chargeable to a different account or combinations of accounts, rendering it difficult or impossible to assign a correct charge account for each job.

In accordance with the forgoing, the subject application teaches example embodiments, detailed below, wherein a user logs in to an MFP device, to complete a document processing operation, either at the device itself or remotely. However, the document processing operation may involve scanning, either to create an electronic document or undertake faxing of one. Once recognized, the identified user is then supplied with menus including a menu listing accounts available to them and corresponding account values, such as page counts or dollar values. Dollar values or credit values may be advantageous insofar as different documents processing operations can be charged at different rates. As used herein, cost centers are comprised of any suitable account value. An account entry may also illustrate special rates or discounts associated with it. For example, a particular account may be with a client that has negotiated special rates. Such a client's account listing may indicate this by special indicia, such as showing their discount. In other situations, the account value may be adjusted relative to its special pricing so that the account would appear to have more value than it would otherwise show. A user is enabled to easily match one or more or jobs with one or more accounts.

As noted above, while scanning may be less expensive than printing, there is nonetheless costs that are incurred. Given the versatility of MFPs and their diverse usage, use of scanning can further undermine MFP cost recovery. For example, a business may not charge a department for scanning, but a charge, such as a per page charge, is assessed for printing, copying or faxing, particularly when long distance phone charges accrue. The business may deem that copying of documents be charged as a fixed rate per page. Printing of documents might not incur a charge until a page limit, 20 pages for example, is exceeded. To avoid copy costs, a user could simply undertake a no cost scan of a 20 page document and save it to an electronic file. The user could then simply print the document and incur no charge. Example embodiments disclosed herein allow for allotment of print quotas or maintaining of a user account against which document processing operations, including scanning or printing, can be selectively managed for charging users. Management of multiple MFPs can be done on a remote server.

It may be common for current MFPs on the market to include a copy quota management feature. This is not the case for scan quota management. Also, user device use permission are typically bundled. That is to say, in situations where the user has sufficient account value for a printout, which may include a print or copy, all device functionality is available to them.

As detailed below, the subject application teaches example embodiments of scan quota management and individual granting of copy or scan permissions. This is accomplished by use of the MFP's functionality, suitably in concert with any suitable third-party account management system, such as PaperCut.

In an example embodiment, a workstation functions as a connector that reads settings from an accounting server, and sets users' account balances for MFP operation. A scan charge can be setup as a fixed scan charge or a per page scan charge. Based on a particular user's balance, administration of a user's scan or copy permissions can be managed separately. The connector compares a user's balance with copy and scan unit price. If the user's balance is greater than both unit prices, then grant all permissions. If their balance is less than both unit prices, then it revokes all device use permissions. If a user's balance is greater than one unit price, but less than another unit price, use permissions are granted only to device functions associated with unit price that is covered by the balance.

In another example, if a scan is charged by page, a scan unit price is set on the MFP. When user's scan quantity is greater than user's balance, a built-in quota management system is able to stop scanning automatically. If a scan is charged by job or by session, when the connector receives a scan notification, it calculates the user's scan cost, and suitably sends it to a server, which may be a third party server, based on user's current balance to adjust the user's permissions of copy or scan dynamically. That is, the system suitably adjusts a user's copy and scan permission after each job. An administrator can selectively enable a scan charging feature. Scan charging is suitably calculated by page, job or session, which option may be selected by the administrator.

User balances are suitably stored on a remote server, such as an accounting server. An administrator is able to set a user's balance on a remote server. After reading all settings from the remote server, the administrator can set each user's quota on MFP as well. A by-page scan charge is also selectable as a scan unit price set on MFPs.

In a further example, the system provides scan notification and scan quota management. After each scan and copy job, an MFP receives workflow notification, and the connector calculates scan job cost, sending it with scan job details to the remote server. The connector suitably resets the user's balance on the MFP, and then re-evaluates the user's copy and scan permission based on the user's current user balance.

As noted above, in an example embodiment, when the user's balance is greater than one unit price, but less than another unit price, they are granted only one operation permission. If a copy unit price is $0.10/page, and scan unit price is $0.03/page when the user's balance is $0.05, their balance is sufficient for a one page scan, but not sufficient for a copy operation. The connector only grants a scan permission and revokes the copy permission for this user.

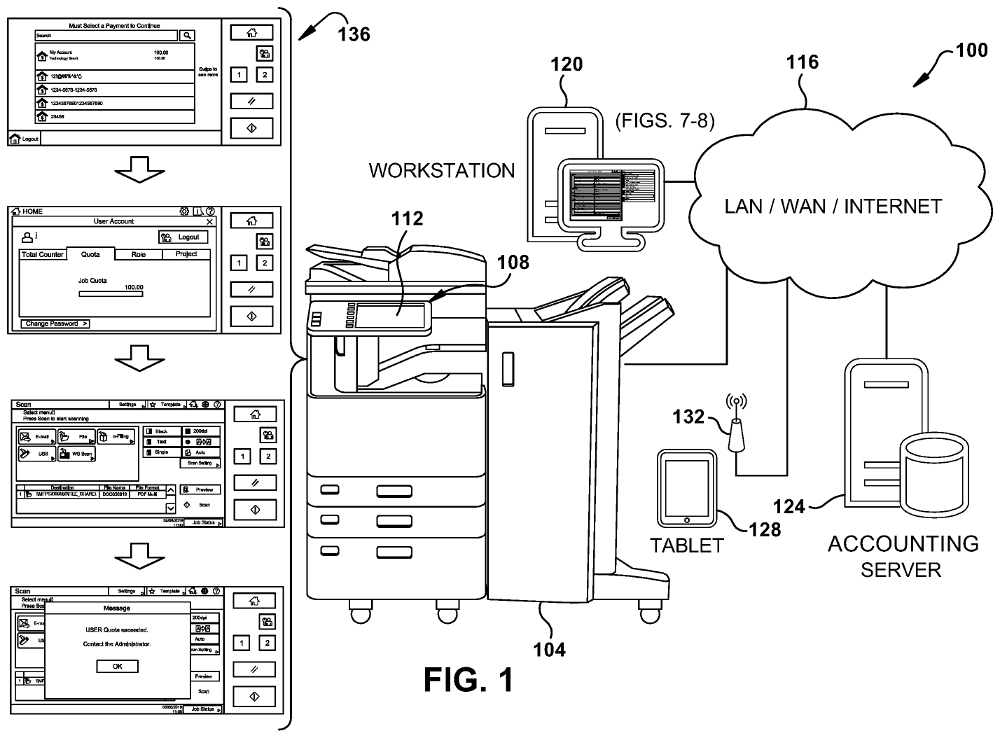

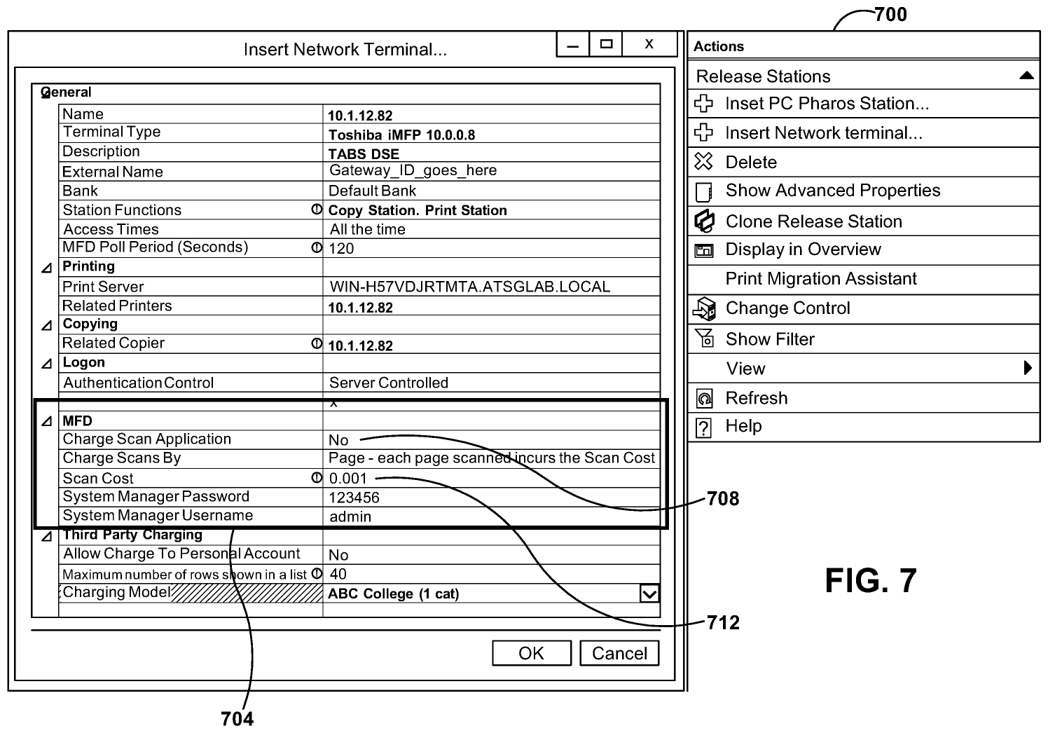

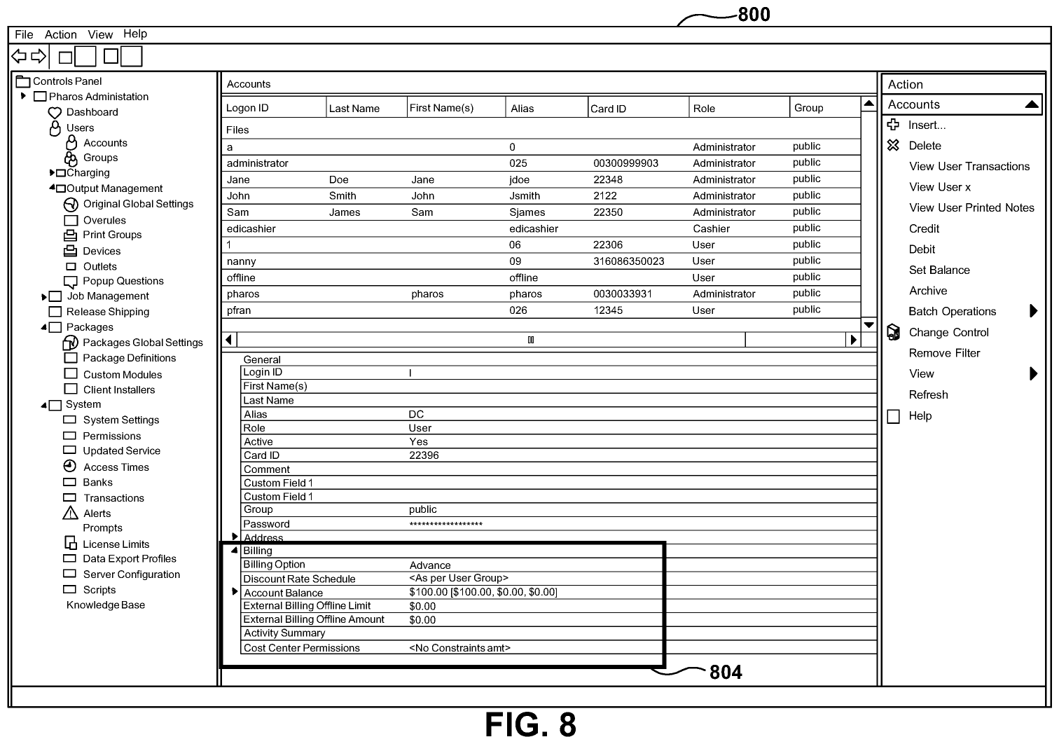

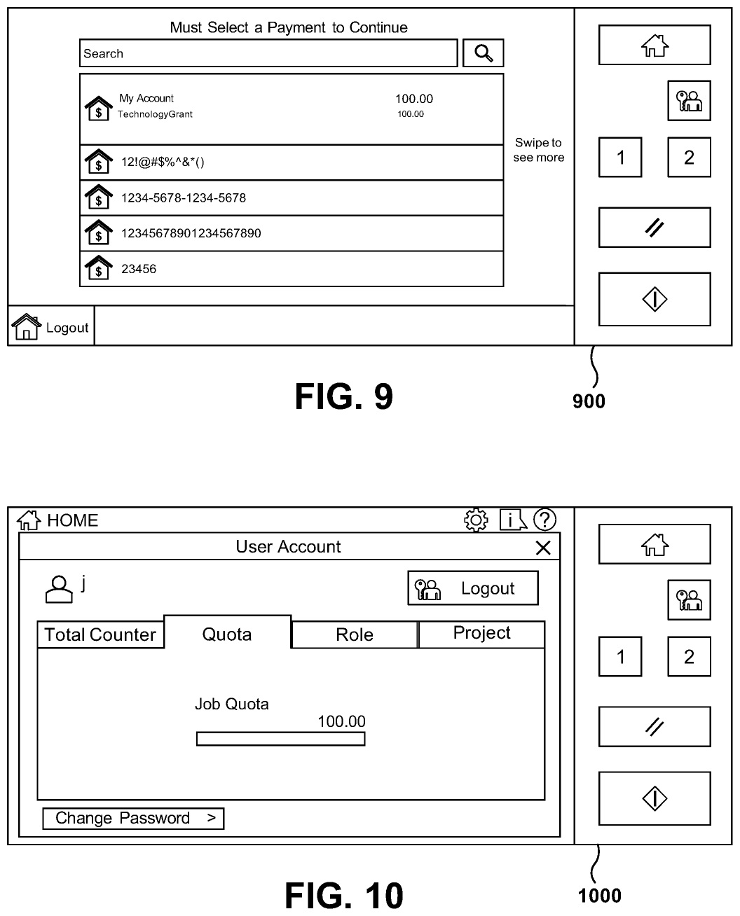

In accordance with the subject application, FIG. 1 illustrates an example embodiment of a document processing accounting system 100 that includes one or more MFPs, illustrated by way of example by MFP 104. MFP 104 includes a user interface 108 suitably comprised of touchscreen 112. MFP 104 is in network communication with network cloud 116, suitably comprised of any wireless or wired local area network (LAN) or a wide area network (WAN) which can comprise the Internet, or any suitable combination thereof. Also in network communication are one or more digital devices including, for example workstation 120, accounting server 124 or tablet computer 128, shown connected to network cloud 116 via access point 132. While a tablet computer is illustrated, it will be appreciated that any suitable portable data device can be used, including smartphones, notebook computers, or the like. Details in connection with operation of workstation 120 will be described in connection with FIGS. 7 and 8, below. An interface display sequence 136 is suitably generated on touchscreen 112 and will be described in greater detail in connection with FIGS. 9-13, below.

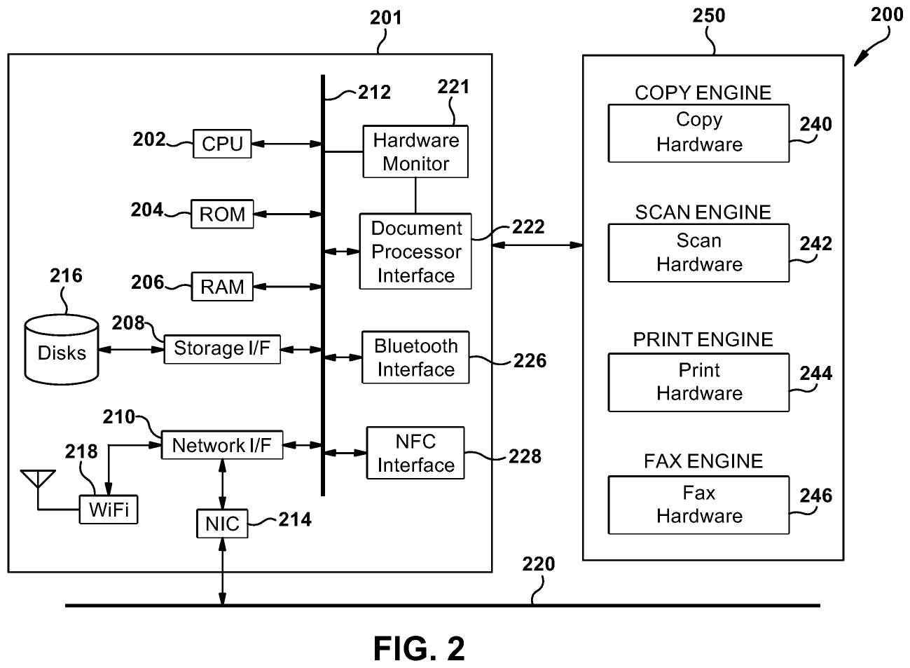

Turning now to FIG. 2 illustrated is an example embodiment of a networked digital device comprised of a document rendering system 200 suitably comprised within an MFP, such as with MFP 104 of FIG. 1. Included in intelligent controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth 226, NFC 228, wireless universal serial bus (wireless USB), satellite, and the like. Example wired interfaces include Ethernet, USB, IEEE 1394 (FireWire), Lightning, telephone line, or the like. Processor 202 is also in data communication with one or more sensors which provide data relative to a state of the device or associated surroundings, such as device temperature, ambient temperature, humidity, device movement and the like.

Processor 202 can also be in data communication with any suitable user input/output (I/O) interface which provides data communication with user peripherals, such as displays, keyboards, mice, track balls, touch screens, or the like. Hardware monitors suitably provides device event data, working in concert with suitable monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 216.

Also in data communication with data bus 212 is a document processor interface 222 suitable for data communication with MFP functional units 250. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

Intelligent controller 201 is suitably provided with an embedded web server system for device configuration and administration. A suitable web interface is comprised of TOPACCESS Controller (sometimes referred to in the subject illustrations as “TA”), available from Toshiba TEC Corporation.

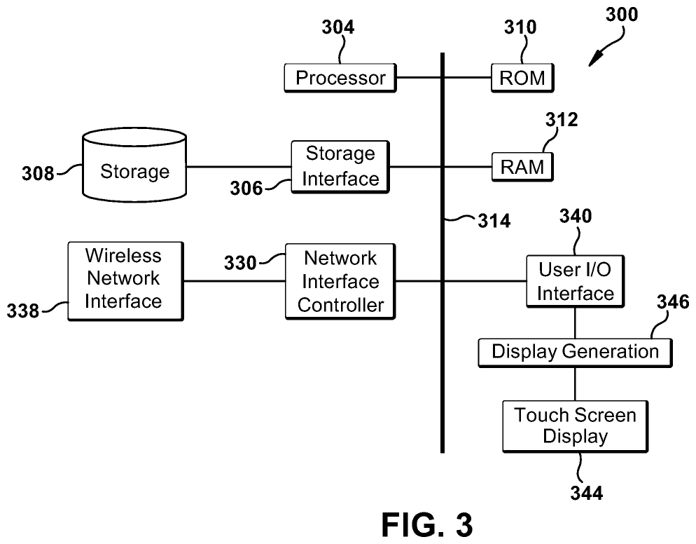

Turning now to FIG. 3, illustrated is an example embodiment of a digital device 300 such as workstation 120, accounting server 124 or tablet 128, or any other suitable data device like a notebook computer, smartphone, and the like. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable wired or physical network connection via physical network interface 330, or to any suitable wireless data connection via wireless network interface 338, such as one or more of the networks detailed above. The system suitably uses location based services. By way of example, if multiple error event management systems are used, it may be advantageous to have monitoring of devices completed by a local or more proximate event management system.

Processor 304 is also in data communication with a user input/output (I/O) interface 340 which provides data communication with user peripherals, such as display 346, as well as keyboards, mice, track balls, or other pointing devices, touch screens 344, or the like. It will be understood that functional units are suitably comprised of intelligent units, including any suitable hardware or software platform.

FIG. 4 illustrates an example embodiment of a MFP use charge system 400 including MFP 404 and server 408. MFP 404 communicates user balance information, as well as scan charging settings and print charging settings with server 408. MFP 404 receives copy notifications and scan notifications in connection with user activity on the device. MFP 404 further functions to selectively grant or deny user scan permission and user copy permission based on a user account balance as detailed further below.

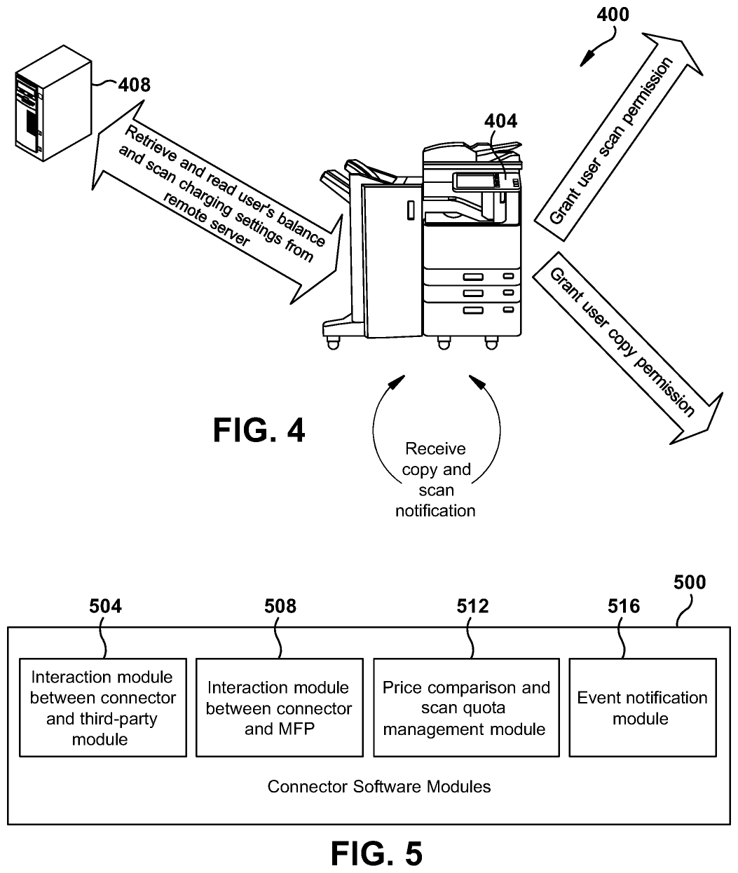

FIG. 5 illustrates an example embodiment of connector software modules 500 to accomplish the selective use permission and user account charging detailed above. Software modules 500 are implemented on a connector device which is suitably comprised of a server, workstation or a combination thereof. As noted above in connection with FIG. 2, an MFP includes a computer in the form of its intelligent controller, so all or some functionality of the connector can be accomplished via an MFP. Software modules 500 includes module 504 which addresses interaction between the connector and a management module, suitably from a third party, as noted above, an example being PaperCut. Module 508 addresses interaction between the connector and MFP. Module 512 addresses price comparison and scan quota management, and module 516 addresses event notification.

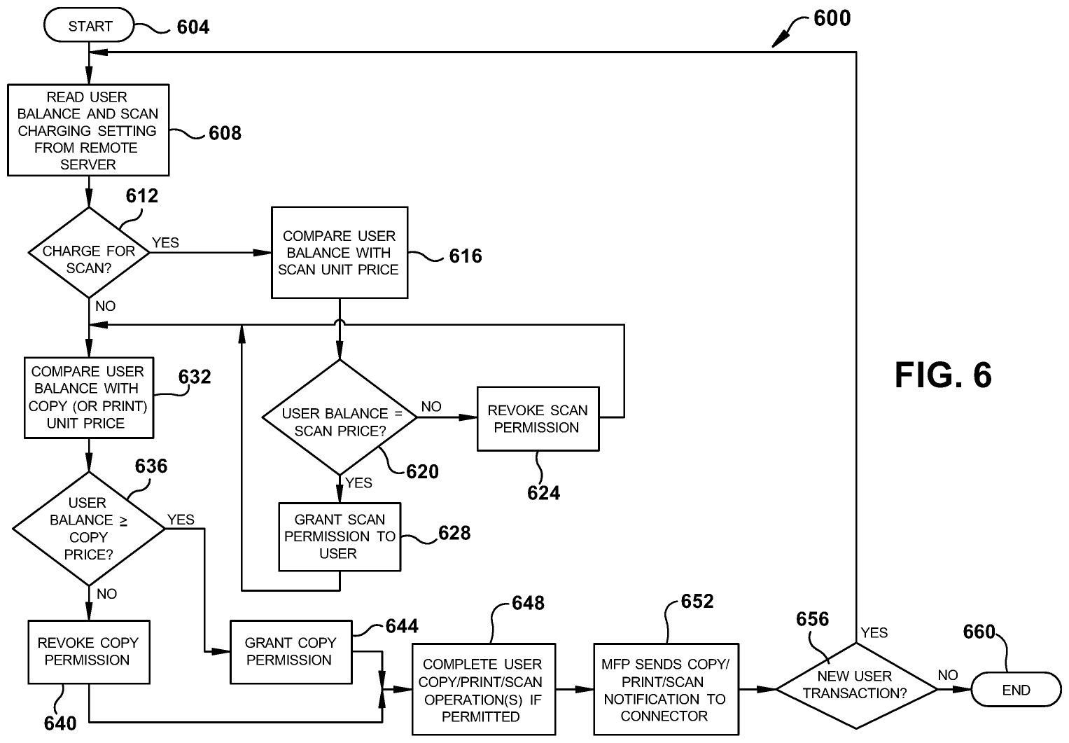

FIG. 6 is a flowchart 600 of an example embodiment of a system for device use cost accounting for different MFP functions, suitably comprised by the software modules of FIG. 5, above. The process commences at block 604 and proceeds to block 608 where a user balance and charging settings, including scan charging settings, are received from a remote server. A check is made at block 612 to determine if scans have been set for charging. If so, a comparison is made between a user's account balance relative to a scan price at block 616. If the balance is less than the scan price as determined at block 620, scan permission for the user is revoked at block 624. Otherwise, the user is given scan permission at block 628. Progress from either block 624 or 628 is made to block 632 to determine the user balance relative to copy (or print) unit price. Copy and print functions often use the same or similar resources for paper output. They can be priced the same or each assigned unique price. In another example, copying may be charged at the cost of one scan page and one print page since both functions are used during copying of a hard document. If the user's balance is less than the copy unit price as determined at block 636, a copy permission is revoked at block 640. Otherwise, copy permission is granted at block 644. Progress from either block 640 or block 644 is made to block 648 where the user's document processing requests are made if enabled with permissions. Next, the MFP sends copy, print or scan notification to the connector at block 652, which allows for recalculation of a user account value in light of operations performed. A test is then made at block 656 if another user transaction is desired. If so, the process returns to block 608. If not, the process ends at block 660.

FIG. 7 is an example embodiment of a connector user interface 700, suitably comprised of workstation 120 or accounting server 124 of FIG. 1, alone or in combination. As illustrated in box 704, an administrator may set charge information, such as the illustrated scan charge information. In the example, the administrator may select whether to charge for scans at box 708 and, if so, specify a charge unit at box 712.

FIG. 8 is an example embodiment of another connector user interface 800 showing user account information at block 804, identifying user information and associated balance information.

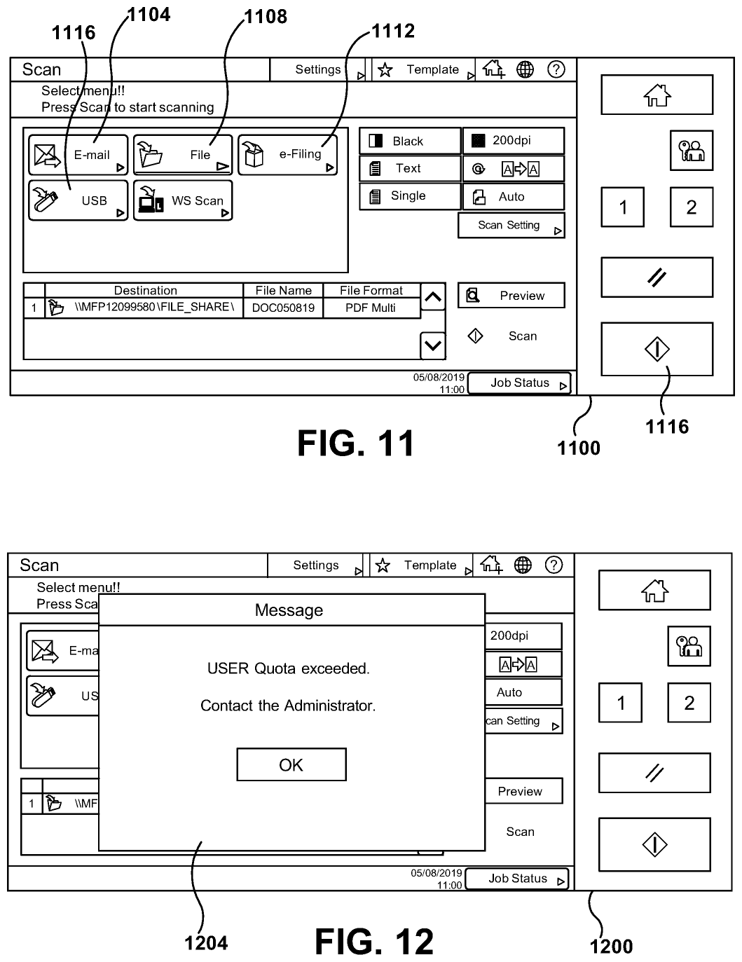

FIG. 9 is an example embodiment of a user account interface 900, suitably displayed on MFP interface 108 or on tablet computer 128 in FIG. 1. In the example, a logged in user is provided with information as to accounts available to them for device use charges. FIG. 10 is an example user interface 1000 showing user accounting by way of quota. FIG. 11 is an example user interface 1100 wherein a user can select a target device for an electronic scan file, including scan to email with button 1104, scan to file with button 1108, scan to e-filing with button 112 or scan to a USB drive with button 1116. Scanning to a selected target is suitably commenced by selecting start button 1116. FIG. 12 is an example embodiment of a user interface 1200 wherein a user is notified with a pop-up message 1204 that they cannot complete a desired document processing operation given denied permission.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a network interface;
a user interface including a user input and a display,
a print engine;
a scan engine;
a user interface including a display and a user input;
memory; and
a processor,
the processor configured to receive a receive a scan request from an identified user,
the processor further configured to receive account data corresponding to a balance of a plurality of accounts associated with the identified user from an accounting server via the network interface, each account being associated with a document processing operation cost schedule and a document processing discount schedule,
the processor further configured determine a scan cost pre-associated with a scan operation for each of the accounts in accordance with an associated cost schedule and discount schedule,
the processor further configured to display determined scan costs for each of the accounts,
the processor further configured to receiving user input specifying a selected account responsive to displayed determined scan costs,
the processor configured determine if a balance of the selected account is sufficient to cover the scan cost, and
the processor further configured to enable operation of the scan engine when the balance is sufficient to cover the scan cost.

2. The system of claim 1 wherein the processor is further configured to enable operation of the scan engine when there is no scan cost.

3. The system of claim 1 wherein the processor is further configured to:
receive a print request from the identified user,
determine if the balance is sufficient to cover a print cost of the print request, and
enable the print engine when the balance is sufficient to cover the print cost.

4. The system of claim 1 wherein the processor is further configured to communicate scan debit data corresponding to a cost associated with operation of the scan engine to the accounting server.

5. The system of claim 4 wherein the processor is further configured to communicate print debit data corresponding to a cost associated with operation of the print engine to the accounting server.

6. The system of claim 5 wherein the processor is further configured to receive the scan cost or the print cost from the accounting server.

7. The system of claim 6 wherein the processor is further configured to generate indicia on the display indicative of enablement of the scan engine or the print engine.

8. The system of claim 7 wherein the user interface is associated with a portable data device.

9. A method comprising:
receiving a scan request from an identified user;
receiving account data corresponding to a balance of a plurality of accounts associated with the identified user from an accounting server via a network interface, each account associated with a document processing operation cost schedule and a document processing discount schedule;
determining, via a processor, a scan cost pre-associated with a scan operation for each of the accounts in accordance with its associated cost schedule and discount schedule;
displaying determined scan costs for each of the accounts on an associated display;
receiving user input via a user interface specifying a selected account responsive to displayed determined scan costs;
determining, via the processor, if a balance of the selected account is sufficient to cover the scan cost; and
enabling operation of a scan engine when the balance is sufficient to cover the scan cost.

10. The method of claim 9 further comprising enabling operation of the scan engine when there is no scan cost.

11. The method of claim 9 further comprising:
receiving a print request from the identified user;
determining if the balance is sufficient to cover a print cost associated with the print request; and
enabling a print engine when the balance is sufficient to cover the print cost.

12. The method of claim 9 further comprising communicating scan debit data corresponding to a cost associated with operation of the scan engine to the accounting server.

13. The method of claim 11 further comprising communicating print debit data corresponding to a cost associated with operation of the print engine to the accounting server.

14. The method of claim 13 further comprising receiving the scan cost or the print cost from the accounting server.

15. The method of claim 14 further comprising generating indicia on a display indicative of enablement of the scan engine or the print engine.

16. The method of claim 15 wherein the user interface is associated with a portable data device.

17. A system comprising:
a network interface;
a user interface including a user input and a display;
memory storing account value data associatively with each of a plurality of identified users,
the memory further storing scan cost data corresponding to cost of a scanning operation on an associated multifunction peripheral; and
a processor,
the processor configured to selectively set a cost or no cost value for a scan operation on the multifunction peripheral in accordance with a user selection made via the user input,
the processor further configured to send the scan cost data to the associated multifunction peripheral when a cost value has been set by the user selection,
the processor further configured to receive an account query for an identified user received from the multifunction peripheral via the network interface,
the processor further configured to communicate the scan cost data to the associated multifunction peripheral responsive to the received account query via the network interface,
the processor further configured to receive, via the network interface, debit data corresponding to a cost of a document processing operation performed on the multifunction peripheral by the identified user, and
the processor further configured to adjust account value data for the identified user in accordance with received debit data.

18. The system of claim 17 wherein,
the memory further stores print cost data corresponding to cost of a printing operation on the associated multifunction peripheral,
the processor is further configured to send the print cost data to the associated multifunction peripheral, and
the processor is further configured to communicate the print cost data to the associated multifunction peripheral responsive to a received account query via the network interface.

19. The system of claim 18 wherein the scan cost data is comprised of a cost per scanned page.

20. The system of claim 19 wherein the processor is further configured to adjust a document processing quota associated with the identified user in accordance with the received debit data.
